(19) United States
(12) Patent Application Publication
(10) Pub. No.: US 2005/0131952 A1
(43) Pub. Date: Jun. 16, 2005

(54) System for collecting data via the internet

(76) Inventor: Masahiro Ito, Ashiya-shi (JP)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 11/042,552

(22) Filed: Jan. 24, 2005

Related U.S. Application Data
(63) Continuation of application No. 09/610,142, filed on Jul. 5, 2000, now abandoned.

(30) Foreign Application Priority Data
May 11, 2000 (JP) 2000-138507

(51) Int. Cl. G06F 7/00

(52) U.S. Cl. 707/104.1

(57) ABSTRACT

A system, for collecting data through the Internet, that is characterized by the inclusion of a means for producing or arranging personal-life information/advice in a question-and-answer format that includes a plurality of questions for obtaining desired data requested by a business-user or other organization-user (hereinafter “business-user”); a means for supplying personal-life information/advice to an individual user, who can receive such information at any time; a means for selecting the aforementioned desired data from the user's answers to a plurality of questions; and a means for supplying to the business-users the data that they desire.

### BACKGROUND OF THE INVENTION

1. Field of the Invention

This invention relates to a system whereby, through the Internet, individual users can obtain personal-life information/advice from business-users that in turn can collect desired data concerning the individual users.

2. Description of the Prior Art

Up to now, businesses and other organizations have unavoidably expended much time and effort in order to collect information concerning such matters as consumers' opinions, evaluations, impressions, knowledge and so on by means of mail inquiries, home visits, or telephone interviews.

Recently, due to the popularization of the Internet, it has become possible for businesses to obtain the desired data mentioned above easily, quickly, and at low cost by transmitting questions and receiving answers via Web pages. However, by Internet research it is difficult to obtain exact or precise data, including personal information, from such answers.

In addition, a user of a mobile phone must pay rather high fees every month in order to obtain services such as personal-life information/advice (for example, divination) concerning matters of interest to the user by use of a telephone connected to the Internet.

One objective of this invention is to inexpensively and quickly collect precise data concerning the personal opinions, evaluations, impressions, knowledge, and so on from a plurality of users via a process whereby the individual user has access to personal-life information/advice supplied by business-users.

Another objective of this invention is to provide to an individual user personal-life information/advice (for example, divination)—in a question-and-answer format, and to obtain, in the answers returned from the individual users, exact or precise data desired by businesses and other organizations.

### SUMMARY OF THE INVENTION

This is a system for collecting data through the Internet, with the system such as to include a means for producing or arranging personal-life information/advice in a question-and-answer format that includes a plurality of questions for obtaining data desired by users such as businesses and other organizations; a means for supplying personal-life information/advice to an individual user, who can receive such information at any time; a means for selecting the desired data from the user's answers to a plurality of questions when accessing personal-life information/advice; and a means for supplying the desired data to the business-users.

The data-collecting system is composed of a computer system containing a set of databases and a central processing unit. The databases include a personal-life information/advice database in which are recorded a variety of personal-life information/advice (for example, divination); an individual-users database in which each individual user is registered, and in which are recorded personal data such as the user's name, gender, address, telephone number, and so on, in order for the user to be able to access the personal-life information/advice, and such other data as the user's access counts (i.e., “hits”) and answers to a plurality of questions concerning personal-life information/advice; a business-users database in which the businesses and other organizations are registered, in order for such a user to obtain data that they desire; a data-requests database in which are recorded a plurality of items concerning data that business-users have requested to be obtained; and an financial records database in which are recorded a variety of financial records, including credits awarded to individual users and business-users in connection with the use of this system.

The central processing unit contains: a means of recording users' names and identification numbers in the individual-users database or business-users database, upon receipt, through the Internet, of a signal received from the terminal computer of an individual user or business-user requesting status as a user; and a means of receiving from a terminal computer of an individual user a request for personal-life information/advice and of supplying or distributing suitable personal-life information/advice (for example, divination) selected by the individual user from the personal-life information/advice database according to the user's interests.

The central processing unit further contains: a means of recording in the data-requests database a request received from a terminal computer of a business-user regarding data that the business-user desires to be obtained; a means of accessing the data-requests database and selecting suitable content from data requests, thereby to formulate questions to be input into the personal-life information/advice; a means of storing or recording in the individual-users database an individual user's answers to the aforementioned questions upon receipt of the user's answers to those questions; a means of accessing the individual-users database and the data-requests database so as to analyze the totality of data accumulated in the individual-users database in order to prepare appropriate research-results reports to be transmitted to terminal computers of business-users; and a means for maintaining in the financial records database a variety of financial records, including fees to be imposed on individual users and business-users for use of this system, as well as remuneration provided by business-users and to be paid to individual users for responding to business-users' requests for research data.

An embodiment of this invention will now be explained in detail with reference to the drawings specified below.

### BRIEF DESCRIPTION OF THE DRAWINGS

FIG. 1 is a diagram showing this invention's system for collecting data.

FIG. 2 is a diagram showing the functional arrangement of the data-collecting system mentioned above.

FIG. 3 is a flowchart showing this invention's research-data-collecting system.

### DETAILED DESCRIPTION OF THE INVENTION

### 1. EMBODIMENT OF THE INVENTION

This invention's system for collecting data through the Internet is characterized by the inclusion of a means (A) for producing or arranging personal-life information/advice in a question-and-answer format that includes a plurality of questions for obtaining desired data that has been requested by users such as businesses and other organizations; a means (B) for supplying the personal-life information/advice to an individual user, who can receive such information at any time; a means (C) for selecting the aforementioned desired data from a user's answers to a plurality of questions in connection with the individual user's obtaining the personal-life information/advice; and a means (D) for supplying the desired data to the business-users.

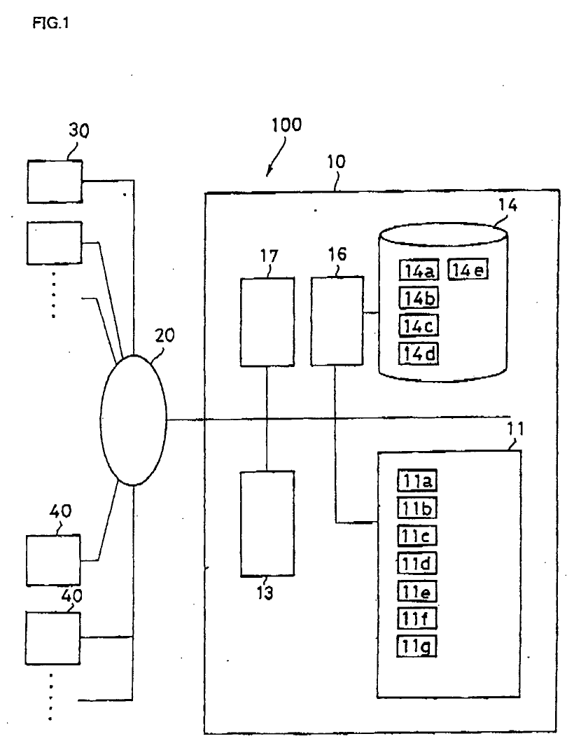

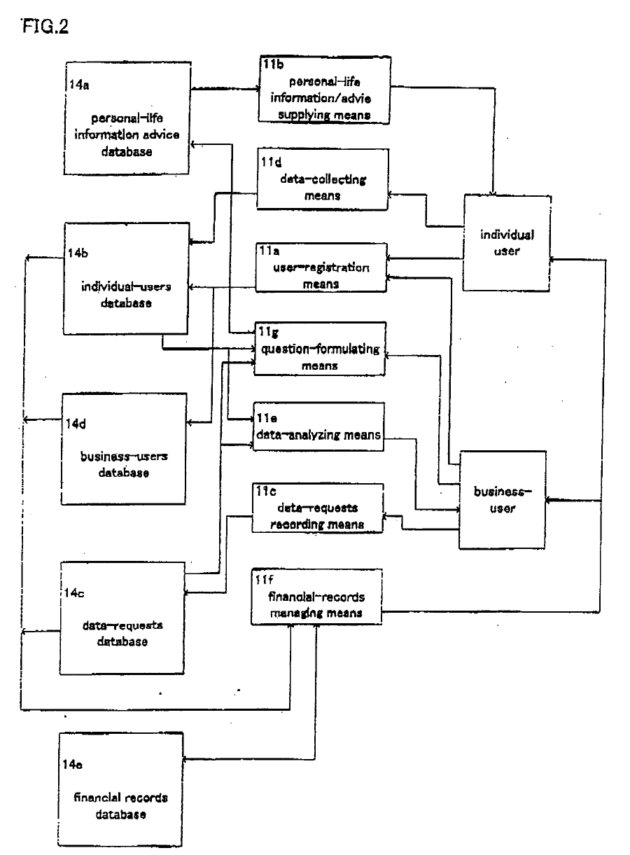

The data-collecting system 10 in the embodiment of this invention as illustrated in FIGS. 1 to 3 consists of a computer system for a research center, business enterprise, or other organization. The data-collecting system can be provided in an office 100 used for providing personal-life information/advice such as, for example, divination, to individual users and for obtaining data requested by businesses or other organizations.

In FIG. 1, because a business-user's terminal computer 30 can access a Web server or a LAN of the data-collecting system 10 through the Internet 20, the business or other organization can use a terminal computer 30 to submit to the data-collecting system 10 in the office 100 a request for the type of data that is desired.

An individual-user's terminal 40 is used to receive personal-life information/advice in a question-and-answer format through the Internet and to transmit to the data-collecting system 10 answers to the questions that are contained in the information. The individual-user's terminal 40 can be a Web server or a portable terminal that can connect with the Internet; for example, a mobile telephone such as the i-mode cellular phone produced and sold by the Nippon Telephone Telegram Corporations, a portable information terminal, or a user's personal computer.

The data-collecting system 10 includes a Web server 13, a connecting circuit (including a firewall) 17, a set of databases 14, a database server 16 that includes a database-server program 16a for managing the set of databases 14 in the database server 16, and a central processing unit 11.

The central processing unit 11 can control in total the data-collecting system 10 and simultaneously to communicate via the Internet with both the business-users' terminals 30 and the individual-users' terminals 40, and can thereby supply new or stored personal-life information/advice in a question-and-answer format to an individual user and obtain data desired by business-users when an individual user's answers to questions are transmitted to the data-collecting system 10.

The set of databases 14 consists of a personal-life information/advice database 14a, in which is recorded a large volume of personal-life information/advice (for example, divination); an individual-users database 14b, in which each individual user is registered, and in which are recorded personal data such as the user's name, gender, address, telephone number, and so on, in order for the user to be able to access the personal-life information/advice, and such other data as the user's access counts and answers to a plurality of questions contained in the personal-life information/advice; a business-users database 14d, in which each business or other organization is registered in order for the business-user to obtain the data that it desires; a data-requests database 14c, in which are recorded a plurality of items or subjects about which business-users have requested data be obtained; and a financial records database 14e, in which are recorded a variety of financial records data, including credits awarded to individual users and business-users in connection with the use of this system.

The central processing unit or controller 11 comprises a user-registration means 11a for recording the name and registration number of each user in the individual-users database 14b or the business-users database 14d, upon receipt of a signal, received through the Internet, from the terminal computer of an individual user or business-user requesting status as a user; and a personal-life information/advice supplying means 11b for receiving a signal from a terminal computer of an individual user and of supplying or distributing suitable personal-life information/advice (for example, divination) selected by an individual user from the personal-life information database 14a.

The central processing unit 11 further contains a data-requests recording means 11c, for recording in the data-requests database 14c the requests for data that have been proposed by each business-user, upon receipt of an appropriate signal from a business-user's terminal computer 30; a question-formulating means 11g, for accessing the data-requests database 14c and selecting suitable content from the requests for data, thereby to formulate questions to be inserted into the personal-life information/advice; a data-collecting means 11d, for recording and storing in the individual-users database 14b each individual user's answers to the questions in the personal-life information/advice, upon receipt of such answers; a data-analyzing means 11e, for accessing the individual-users database 14b and the data-requests database 14c so as to analyze the totality of data collected in the individual-users database 14b in order to prepare appropriate research-results reports to be transmitted to business-users' terminal computers 30; and a financial-records managing means 11f, for maintaining in the financial records database 14e a variety of financial records, including fees to be imposed on individual or business-users in connection with their use of this system, and remuneration to be paid to individual users for responding to the business-user's request for research data, if such remuneration has previously been provided for by a business-user.

In this embodiment, the producing or arranging means (A) mentioned above is applied to or is involved in the question-formulating means 11g of the computer system 10 as an essential element. Similarly, the personal-life information/advice supplying means (B), and the data-selecting means (C) and the results-data supplying means (D) are applied to the personal-life information/advice supplying means 11b and the data-analyzing means 11e, respectively.

By way of further explanation, the user-registration means 11a can either to access the business-users database 14d when a request to register a business-user is sent from the terminal 30 of a business enterprise or other organization in order to obtain desired research data, or can send the registration-input data in a prescribed format to the business-user's terminal 30 if that business-user has not registered previously, and to register the business enterprise or other organization in the business-users database 14d as a new user upon receipt of that user's response.

The user-registration means 11a can either access the individual-users database 14b when a request to register a individual user is sent from an individual-user's terminal 40, or can send registration-input data in a prescribed format to the individual-user's terminal 40 if that individual user has not registered previously, and to register that individual user in the individual-users database 14b as a new user upon receipt of that person's response.

The data-requests recording means 11c also can send a prescribed data-request input form to the business-user's terminal 30, by which form the business-user inputs the contents of its request, which in turn is input into the data-requests database 14c when the research-data request reaches the central processing unit 11 through a signal sent from the business-user's terminal 30. The question-formulating means 11g receives the request and automatically formulates, according to the content of the request, questions suitable for insertion into the personal-life information/advice to be transmitted to individual users.

The data-requests database 14c that is used for formulating questions relevant to the data desired by a business-user includes the business-user's registration number, and the desired data items, time period for data collection, subject area(s), and contents to be researched.

The personal-life information/advice supplying means 11b can access the individual-users database 14b when an access request is received from an individual-user's terminal 40, and can then transmit suitable personal-life information/advice (for example, divination) selected from the personal-life information/advice database 14a via the personal-life information/advice supplying means 11b when the individual user returns the his or her key data, such as a date, time, and so on, that matches the individual user's personal characteristic or trait.

Simultaneously, the personal-life information/advice supplying means 11b interacts with the data-collecting means 11d so as to select from the life support-information database 14a only those questions whose subject areas are identical with those in the data-requests database 14c and then it transmits the appropriate Web page and receives the user's answers to the questions. Then the personal-life information/advice supplying means 11b provides the personal-life information/advice that is appropriate for the user's answers. The data-collecting means 11d collects and stores in the individual-users database 14b the answers to the questions in the selected personal-life information, then directly transmits new data to the data-requests database 14c when the individual user returns answers to those questions, and then transmits the updated data as a research report to the business-user's terminal 30.

The data obtained through the answers of individual users includes such matters as a user's opinions, evaluations, impressions, knowledge, and so on, and in particular the contents of the user's answers might consist of precise data relating to the user's everyday personal life, as mentioned hereinafter. When an individual user accesses the system of this invention so as to submit a request to the personal-life information/advice supplying means 11b, that user receives a question such as “What comic character do you like?” The user then chooses an answer from five alternatives, such as “Doraemon, Sazae-san, Pikachu, Tensai-Bagabon, or Gandum.” If the user chooses, for example, the character Doraemon, the user then gets advice such as “Today you are in an unbalanced condition, so please use care when . . . ” as information/advice suitable for the user's personal life.

A question for obtaining data related to the user's daily-life locale might be, for example, “Which ramen shop do you think is the best in the Shibuya area?” The user is then given a list of ramen shops from which to choose. The data that is obtained from the user's choice is then accumulated, via the data-collecting means 11d, with data obtained from other users and the accumulated data is then used to create a popularity-ranking list of ramen shops in the Shibuya area. That list is then immediately transmitted to the appropriate individual-user's terminal 40. In this way, individual users can know which is the most-popular shop.

Questions designed to obtain personal information can be combined with questions proposed, for example, by a newspaper company, in surveys of public opinion on such matters as the support rate of a new prime minister, consumption trends, or awareness of specified goods, in order to get exact answers from users in their societal roles as consumers or voters.

A request for personal-life information/advice is received by the personal-life information/advice means 11b, which will search the individual-users database 14b, from which personal-life information/advice such as divination and so on is transmitted to the individual-user's terminal 40, based upon the personal characteristics or traits of the individual-user and the date and time of the request for the information/advice.

Simultaneously, the personal-life information/advice supplying means 11b can be utilized so that prepared questions such as, for example, “How are you feeling?”, are supplied to the individual user together with other questions, including those concerning the user's opinions, evaluations, impressions, knowledge, and so on, in response to a previous data request of a business-user, with the latter questions being selected and combined with the former questions by the question-formulating means 11g, with the questions then being sent to the individual user by the personal-life information/advice supplying means 11b. The data-collecting means 11d is used to receive the user's answers.

When the personal-life information/advice supplying means 11b receives a data request from an individual-user terminal 40, and then automatically provides personal-life information/advice, including suitable questions, selected from the personal-life information/advice database 14a, the data-collecting means 11d interacts with the personal-life information/advice supplying means 11b to select or apply the personal characteristic or trait from the individual-users database 14b if the personal characteristic or trait is in accord with the research objective in the data-requests database 14c, and then the data-collecting means 11d receives the user's answers. For example, the personal-life information/advice supplying means 11b supplies questions as selected in the request field by the user, such as “What are the 10 best restaurants (or ramen shops)?” and obtains the user's answers thereto.

The data-collecting means 11d immediately updates the data in the data-requests database 14c based on answers received from the user, so as to transmit the accumulated research-results data to the business-user's terminal 30, including data regarding the personal life of the individual user, based on the user's answers.

The data-analyzing means 11e classifies the user's response data for statistical processing in terms of such factors as the user's age, occupation, and so forth, thereby obtaining analytical results concerning the user's opinions, evaluations, impressions, knowledge, and so on, and then distributes those results to the appropriate business-user terminal 30.

The financial-records managing means 11f stores and manages a variety of financial data contained in the financial records database 14e. These records include the expenses incurred by business-users in obtaining the desired data; the access counts of individual users, derived from the individual-users database 14b; and data concerning data-research requests, derived from the data-requests database 14c, and data regarding compensation to be paid. Furthermore, the financial-records managing means 11f electronically executes, through the Internet, payment-deposits to or expense-debits from users' bank accounts.

Next is explained a case in which an individual user provides personal information for a price proposed by a business-user. In such a case, the business-user has previously registered in the data-requests database 14c a request for certain data, with a price to be offered to an individual user, to be selected by lottery, who responds. When a user answers such a question on the search Web page, then the personal-life information means 11b, upon the individual user's access, sends the data-request question to the individual user, and the data-collecting means 11d transmits to the business-user as lottery-entry information the individual user's answer, together with information in the individual-users database 14b concerning that user's personal characteristics or traits.

After the lottery-entry period has expired, the business-user selects the prize-winning person(s) from among the entrants, then sends the prize offer to the selected person(s) directly or through an exchange system. The business-user then gets the precise data that it desires, such as the user's name, address, and so on.

With this invention, precise data and detailed reports can be obtained concerning an individual user, such as the user's name, birthday, gender, and so on, because such information is obtained as the user's answer when the personal-life information/advice (for example, divination) is offered to the individual user.

The personal-life information/advice mentioned above particularly includes information for use in selecting individual users to whom a business or organization will offer premiums or prizes.

With this invention, a business-user can obtain personal information, such as a user's name, birthday, gender, and so on, when the user obtains personal-life information/advice in order to enter a prize contest through the Internet.

The terminal computer for an individual user can be a mobile phone or other portable terminal that can be connected to the Internet.

With this invention, a large volume of data can be economically obtained in a short time, because the data is automatically collected from users through the Internet by means of a data-collecting system.

With this invention's data-collecting system as mentioned above, the contents of research questions comprise: a first question unit that has a keyword by which the personal-life information/advice that relates to the everyday personal life of the individual user is automatically selected; a second question unit for obtaining the user's opinions relating to the user's living area; and a third question unit that matches the user's opinions, evaluations, impressions, knowledge, and so on, with a data request from a business or other organization, whereby the user can select at least one question from a plurality of alternatives.

With the data-collecting system just mentioned above, the collecting-data means can distribute personal-life information/advice that is suitable for a user, based on either the user's answers to questions or the search results in total.

With this invention, research can be accomplished by combining a user's precise opinions, evaluations, impressions, knowledge, and so on, based on the user's answers to specified questions (when the user seeks to obtain personal-life information/advice), with information concerning the user's personal interests or characteristics.

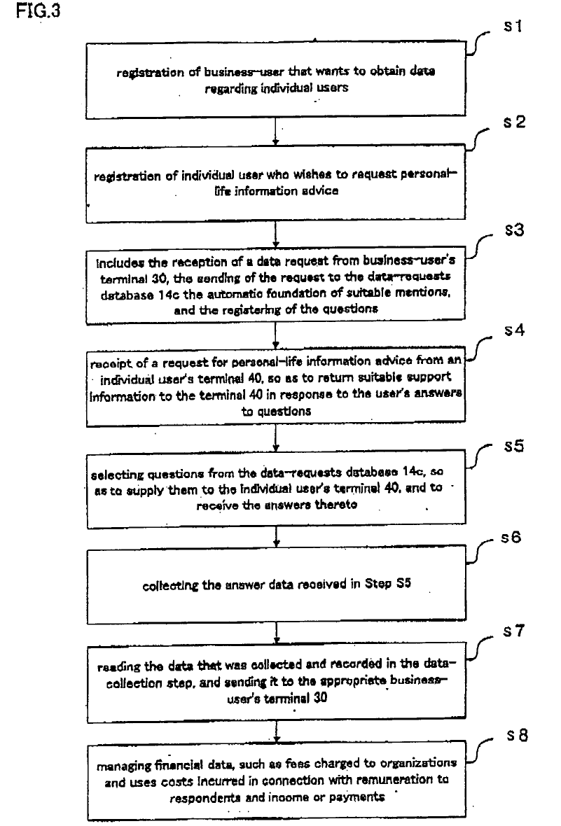

FIG. 3 is a diagram showing the flow of operations of this invention's system for collecting data. S1 is a step for registering business-users, namely, companies or other organizations (the user-registration means 11a inputs the registration data into the business-users database 14d), and S2 is a step for registering individual users, namely, individual people who wish to request personal-life information/advice (the user-registration means 11a inputs the registration data into the individual-users database 14b).

S3 is a step that includes the reception of a data request from a business-user's terminal 30 (the data-requests recording means 11c inputs the data request into the data-requests database 14c), the automatic formulation of suitable questions to be included with personal-life information/advice (the question-formulation means 11g inserts the questions into the personal-life information/advice that is produced and inputs them into the personal-life information/advice database 14b).

S4 is a step for receiving requests for personal-life information/advice from an individual-user's terminal 40, so as to send suitable personal-life information/advice to the individual-user's terminal 40 after the individual user selects the type of personal-life information/advice that he or she desires (the personal-life information/advice supplying means 11b selects information/advice from the personal-life information/advice database 14a).

S5 is a step for selecting data requests from the data-requests database 14c and then formulating questions suitable to the personal-life information/advice being provided (achieved by the question-formulation means 11g), so as to transmit to the individual-user's terminal 40 personal-life information/advice that includes questions (the personal-life information/advice supplying means 11b transmits the questions to the individual-user's terminal 40) and finally to receive the answers thereto (by use of the data-collecting means 11d).

S6 is a step for accessing the data-requests database 14c and the individual-users database 14b (the data-analyzing means 11e analyzes the totality of answers stored in the individual-users database 14b and selects data that is relevant to requests of business-users) so as to supply it to business-users' terminals 30.

S7 is a step for reading the data that is in the individual-users database 14b and that was collected and recorded in the data-collection step (by use of the data-collecting means 11d) and then sending it to the business-users' terminals 30 after statistical processing (by use of the data-analyzing means 11e).

S8 is a step for managing records concerning financial data, such as fees charged to business-users and individual users, expenses incurred in connection with awarding prizes to individual user-respondents, and income or payments (financial-records managing means 11f).

1-7. (canceled)

8. A method of collecting data through the Internet, comprising the steps of:
(A) collecting survey data requests by businesses seeking information from users;
(B) generating plural sets of questions to ask the users based on the survey requests collected in step (A);
(C) receiving requests from the users for personal-life information;
(D) selecting a set of questions from the sets generated in step (B) based on the type of personal-life information sought by the user in step (C);
(E) transmitting the set of the questions selected in step (D) and personal-life information to the user;
(F) collecting answers to the set of the questions transmitted by the users in step (E); and,
(G) transmitting to the businesses, information contained in the answers collected in step (F).

9. The method of claim 8, including the step of associating the set of the questions generated on step (B) with types of personal-life information.

10. The method of claim 9, wherein the subject area of the set of the questions and personal-life information transmitted to the user in step (E) is identical.

11. The method of claim 9, including the step of storing the personal-life information and the set of associated questions in a database.

12. The method of claim 8, wherein the personal-life information transmitted to the user in step (E) is based on past answers collected from various users in step (F).

13. The method of claim 8, wherein step (E) is performed by inserting the questions into the personal-life information/advice transmitted to the user.

14. The method of claim 8, wherein step (B) includes formulating questions seeking both personal information and survey data requested by the businesses.

15. The method of claim 8, wherein step (E) is performed by transmitting the personal-life information and the questions together.

16. The method of claim 8 wherein the personal personal-life information transmitted to the user includes information concerning premiums or prizes being offered to users by a business.

17. The method of claim 8 wherein the questions include: a first question unit that has a keyword by which the personal-life information that relates to the everyday personal life of the individual user is automatically selected; a second question unit for obtaining the users opinions relating to the user's living area; and a third question unit that includes data that is sought by the businesses, namely, the users opinions, evaluations, impressions, and knowledge, with the data requests of the businesses, whereby the user can select at least one of question to be answered from plural alternative questions.

18. A system for collecting data through the Internet, comprising:
means for producing and editing personal-life information/advice in a question-and-answer format that includes a plurality of questions to be answered by individual users in order to provide data requested by business users, the producing and editing means including—
(a) a first data base containing personal-life information/advice;
(b) a second database containing requests for data from the business users,
(c) means for formulating the questions using data from the first and second databases;
means for supplying the personal-life information/advice and the formulated questions to the individual users, who can receive the information at any time;
means for collecting and analyzing the desired data based on the individual users' answers to the formulated questions when the individual users are obtaining personal-life information/advice; and,
means for supplying the desired data after it has been collected and analyzed, to the business user.

19. A data-collecting system, as claimed in claim 18, including:
a computer system that includes a set of databases and a central processing unit, wherein the set of databases includes the first and second databases;
an individual-users database, in which each individual user is registered and in which are recorded data identifying an individual user in order for the user to be able to access the personal-life information/advice, as well as other data including the user's access counts and answers to the formulated questions;
a business-users database, in which the businesses are registered in order for them to be able to request that specified desired data be obtained;
a financial records database in which are recorded a variety of financial information, including credits due to the individual users and businesses in connection with the use of the system;
the central processing unit containing means for recording the names and identification numbers of users in the individual-users database or the business-users database, upon receipt of a signal, sent through the Internet, from the terminal computer of an individual user or business-user for authentication as a user;
means for receiving a request from a terminal computer of an individual user of referring to the personal-life information/advice database, and of transmitting to the user suitable personal-life information/advice that is selected according to the interests of that individual user;
means for recording into the second database the business-users' requests for data to be obtained upon receipt of a request from a terminal computer of a business-user;
means for referring to the second database and selecting the type of data to be obtained, thereby to formulate the questions;
means for recording in the first database individual users' answers to the questions, upon receipt of the individual users answers to those questions;
means for accessing the first and second databases so as to analyze the totality of data accumulated in the first database in order to prepare appropriate research-results reports to be transmitted to the terminal computers of the business-users; and,
means for maintaining in the financial records database a variety of financial records, including fees to be imposed on individual users or business-users for the use of this system.

20. A data-collecting system, as is claimed in claim 18, in which the system includes a means for paying to individual users remuneration provided in advance by the business-users for responding to requests for data from the business users.

21. A data-collecting system, as is claimed in claim 18, in which the personal personal-life information/advice includes information concerning premiums or prizes being offered to the individual users by a business.

22. A data-collecting system, as is claimed in claim 18, in which an individual-user's terminal computer is a cellular telephone or other mobile terminal.

23. A data-collecting system, as is claimed in claim 18, in which the contents of the formulated questions comprise a first question unit that has a keyword by which the personal-life information/advice that relates to the everyday personal life of the individual user is automatically selected; a second question unit for obtaining the individual user's opinions relating to the individual user's living area; and a third question unit that includes date that is sought by the businesses, namely, the individual user's opinions, evaluations, impressions, and knowledge, with the data requests of business users; whereby the individual user can select at least one question to be answered from plural alternative questions.

24, A data-collecting system, as is claimed in claim 18, in which suitable personal-life information/advice is distributed to an individual user on the basis of the accumulated data-collecting results or the individual users answer, selected from among plural alternatives, to the questions, when data is collected.

25. A data collecting system as claimed in claim 18, in which the first database includes at least one of the user's: name, gender, address, telephone number, age, occupation, marital status and nationality.
